(19) United States
(12) Patent Application Publication
(10) Pub. No.: US 2006/0217267 A1
(43) Pub. Date: Sep. 28, 2006

(54) Novel product for agricultural use which is obtained from distillery spent wash and sludge

(75) Inventor: Daniel Irisarri Navalpotro, Laukiz Vizcaya (ES)

Correspondence Address: FULWIDER PATTON, 6060 CENTER DRIVE, 10TH FLOOR, LOS ANGELES, CA, 90045, US

(73) Assignee: Kimel Aditivos, S.L., Laukiz (Vizcaya) (ES)

(21) Appl. No.: 10/565,459

(22) PCT Filed: Jul. 6, 2004
(86) PCT No.: PCT/ES04/00322

§ 371 Date: Jan. 20, 2006

(30) Foreign Application Priority Data
Jul. 23, 2003 (ES) 04/000322

(51) Int. Cl. A01N 63/00

(52) U.S. Cl. 504/117

(57) ABSTRACT

The present invention provides a product for agricultural use in the form of granules or pellets, characterised by comprising at least 4% (w/w) of vinasses and/or sludge measured as a dry extract of vinasses and/or sludge, and an organic or inorganic solid support. In addition, the present invention provides a procedure for producing said product, its use in agriculture and a method for applying said product to an agricultural extension to be treated.

### TECHNICAL FIELD OF THE INVENTION

The present invention relates to the field of products for agricultural use and, more specifically, to products in the form of granules or pellets obtained from vinasses, sludge or effluent by-products of distilleries.

### PRIOR STATE OF THE ART

In general, the term “vinasses” refers to effluents produced in distilleries of any type and, specifically, effluents obtained in the process of fermenting sugar cane or beet. The term “sludge” refers to effluents obtained from cleaning the raw materials, cleaning the fermentation tanks and cleaning the tanks in which the vinasses are stored. These effluents have a variable qualitative and quantitative composition, but generally contain water, metal ions, yeasts, remainders of non-fermentable sugars, lignin, sulphates and other sulphur compounds and mainly organic material composed of polymerical complexes.

The standard procedures for industrial production of ethanol from sugar cane comprise the following general steps:
Grinding the sugar cane to obtain its juice;
Concentrating said juice until obtaining a solution with a 20-30% content of insolubles diluted in water to 50%; and
Fermenting, in a manner that varies in each distillery, wherein said diluted solution is added yeast in an amount sufficient to ferment sugars and sulphuric a cid to lower the pH (to approximately 3.7-3.8), thereby producing alcohols, mainly ethanol, and unfermented products.

After the alcohol is separated, effluents are produced loaded with unfermented products known generically as vinasses. For each litre of alcohol, approximately 12-14 litres of vinasses are produced. Considering that a medium-sized distillery produces about 50,000 litres of alcohol per day, the daily production of residual effluents amounts to 700,000 litres, which for at least 250 days a years implies the production of about 175,000,000 litres (175,000 m³) of residues a year.

Said massive production effluents ferment almost spontaneously, producing very unpleasant sulphurous odours, in addition to being highly polluting due to their high chemical oxygen demand (COD) and biological oxygen demand (BOD) due to their great ability to capture oxygen from the receptor medium, producing significant harm to the living conditions of surrounding flora and fauna. Thus, an average distillery producing 50,000 litres of alcohol a day pollutes as much as a city of 500,000 persons.

In certain locations, when the distillery is located near the plantations, its residues are used to water the crop. However, its unpleasant odour and cost of transport does not make this use advisable.

The most common form of elimination of these residual effluents is uncontrolled discharge in rivers, lakes or seas, which causes serious harm to the environment.

The bottom of the raw material storage tanks and their different forms or states in the progress of the Process of the distillery are collectively known as “sludge” and is also polluting, for the same reasons as vinasses, as they contain the same components—albeit in different proportions—and therefore must be inertised before being taken to authorised dumps.

Thus, there are great environmental problems related to the elimination of such a highly polluting residue produced in such large amounts as vinasses and sludge by uncontrolled discharge into water reservoirs, seas or elsewhere.

One of the solutions proposed is the re-utilisation of said vinasses and sludge in applications of various technical fields.

Hitherto, the re-utilisation of vinasses as produced in distilleries, i.e. untreated, has been performed in the agricultural sector in an uncontrolled manner, as discussed above. In addition, the use of said unprocessed vinasses in agricultural applications has serious drawbacks, as the vinasses are generally found in the market as a concentrated liquid (about 50% w/w) and have the disadvantages related to a liquid application. In dry weather periods they can be used placing them on solid granules in an operation that is considerably more complex than that of mixing granules, requiring the use of deposits to contain them on the same tractor with the mechanical granule hopper. In addition, in rainy weather this cannot be done, as rainwater will instantly dissolve the liquid.

In recent years procedures for processing said liquid vinasses have been developed in various industrial sectors, such as lignosulphates (see Spanish Patent ES 2113820) and other polymerical materials (see Spanish Patent ES 2158751). More specifically, Spanish Patent ES 2113820 describes the production of lignosulphates from liquid vinasses applicable in the industry as a binding agent for manufacturing ceramic and refractory items, as a binding agent in animal food, ground stabilisation, production of light aggregates for civil construction work, in the manufacture of glues, etc. Likewise, Spanish Patent ES 2158751 describes a procedure for obtaining polymerical complexes from liquid vinasses with industrial application in the manufacture of water reducers, sprayers, tensioactive products, adhesives, binders, etc.

However, despite the current use of vinasses as described above, their production greatly exceeds demand, so that the interest in finding new applications for these residues remains active.

In this context, the present inventors have discovered that it is possible to use vinasses and sludge in agricultural uses in a controlled manner that is not only not polluting but in fact can even be beneficial.

Research made by the inventors in the Fishing and Food Institute (Instituto Pesquero y Alimentario) AZTI show that the pollutants in vinasses and sludge result from the organic part that ferments, but that said organic part, when applied in a controlled manner in agriculture, is beneficial to plants due to the content in low molecular mass polymerical complexes, such as organic acids, glycerine (in some cases), carboxyl groups, etc. that help to complex and chelate the nutrients and improve the cationic exchange capacity (CEC). In turn, the inorganic content, mainly potassium and smaller amounts of nitrogen and phosphorus, as well as some microelements, improve the nutrition of plants.

Sludge, in addition to the organic and mineral fraction of vinasses, contains calcium, an element needed to desalinise soil and for the correct formation of some horticultural products. It also contains yeasts, which contain proteins, which when transformed by micro-organisms in the soil become amino acids. Plants, as humans, need amino acids to carry out vital functions.

This controlled use of vinasses and sludge in agricultural applications developed by the inventors consists of a direct application on the sol of a product in the form of granules or pellets obtained from vinasses and/or sludge produced in distilleries, which contains at least 4% (w/w) vinasses and/or sludge (measured or expressed as dry extract), the remaining 96% being the solid support, either separately or together with other products of agricultural use.

In this way, the application of vinasses and/or sludge in the form of granules or pellets, mixed or not with other products of agricultural use in the form of granules or pellets, becomes a feasible, simple and cheaper operation (not requiring any investment, nor control of tanks and application flow rate).

In addition, large intensive crop plantations are mechanised, allowing to apply large volumes and employ the large amounts of vinasses and sludge produced in distilleries.

Thus, this re-utilisation of the vinasses and sludge produced in distilleries implies a number of advantages over the prior art:
Large volumes of vinasses and sludge are reutilised, therefore reducing environmental problems;
The product obtained from them is easily applied and is an ecological material as per current legislation (EEC Regulation 2092/91);
The costs of obtaining the product and applying it are both reduced, obtaining additional income by its commercialisation.

### OBJECT OF THE INVENTION

One object of the present invention is to obtain a product of agricultural use in the form of granules or pellets comprising at least 4% (w/w) vinasses and/or sludge measured or expressed as dry extract of vinasses and/or sludge and an organic or inorganic support.

Another object of the present invention is to provide a procedure for producing said product.

An additional object of the present invention is to provide the use of said product in agriculture.

Lastly, another object of the present invention is to provide a method for applying said product to a crop extension to be treated.

### DESCRIPTION OF THE INVENTION

The present invention provides a product for agricultural application in the form of granules or pellets characterised in that it comprises at least 4% (w/w) vinasses and/or sludge and an organic or inorganic solid support (referred to hereinafter as the “product of the invention”).

In general, it is advised to state the richness of the product in vinasses or sludge by the percentage of vinasses or sludge expressed as a dry extract.

In a preferred embodiment, the product of the invention comprises 4-95% (w/w) vinasses and/or sludge measured as a dry extract of vinasses and/or sludge and the remaining 96-5% being the solid support needed to obtain the product in the form of a granule or pellet.

In another more preferred embodiment, the product of the invention comprises 4-50% (w/w) vinasses and/or sludge measured as a dry extract of vinasses and/or sludge and 96-50% in the form of a solid support.

In an even more preferred embodiment, the product of the invention comprises 13% (w/w) vinasses and/or sludge measured as a dry extract of vinasses and/or sludge and 87% in the form of a solid support.

In another aspect of the invention, a process is provided to produce the product of the invention, characterised in that it comprises a step of addition of vinasses and/or sludge in solid or liquid form to a solid support for granulation or pelletisation.

In a specific embodiment, the procedure for producing the product of the invention comprises a step of adding the concentrated liquid vinasses and/or sludge in at least 25% (w/w) to a solid granulation or pelletisation support.

In another specific embodiment, the procedure for producing the product of the invention comprise a step of adding the solid vinasses in the form of powder and/or dry sludge to a solid granulation or pelletisation support.

Vinasses leave the distillery distillation column in concentrations ranging from 2% al 12%, approximately, and are later concentrated in the same distillation plant by concentrators that can use the latent heat of the distillery, or in separate installations.

After the vinasses have been concentrated they can be dried and turned to powder, which is difficult to use as such in agricultural applications, so that its use in these applications is attempted in the form of a granule or pellet, requiring an organic or inorganic support that hardens the granule and eliminates its moisture capacity.

Granules/pellets are obtained more easily the greater the concentration of the vinasses, or the more powdered vinasses and/or dry sludge, as applicable, is used. The granulation or pelletisation will be performed by any conventional procedure known to an expert in the field, in any granulation/pelletisation installation commonly used in the state of the art. Normally, a mechanical device is used for forming the granules/pellets in which the vinasses, liquid or powder, and/or the sludge, are mixed with the solid support and a drying device in which the granules/pellets are dried after they are formed.

The amounts of vinasses, liquid or in powder, and/or sludge and solid support must be considered to calculate and know the percentage of concentrated vinasses and/or sludge contained in the granules/pellets.

The function of the aforementioned solid support, in addition to favouring the granulation or pelletisation operation, is to provide a complementary composition of organic or inorganic matter beneficial to plants and crops.

Thus, in a preferred embodiment, the solid granulation or pelletisation support can be an organic substance such as cane bagasse or composted organic matter, or an inorganic substance such as clays, silicates, nitrates or sulphates.

In another aspect of the invention it is provided the use in agriculture of the product of the invention. More specifically, it is provided the use of the product preferably as a fertiliser, a nutrient enhancer, a soil conditioner, a desalinisation agent, a complexing or chelating agent for nutrients, a soil organic matter stabiliser, a mixture enhancer, a pH improver and regulator, a cationic exchange capacity improver, or as an organic matter of almost instant availability.

Lastly, another aspect of the present invention provides a method for application to an agricultural extension to be treated with the product of the invention, characterised in that it involves applying the product directly to the soil of said agricultural extension to be treated.

In a specific embodiment of the invention, the application of the product involves: 1) mixing the product of the invention with other products of agricultural use in the form or granules or pellets; and 2) applying said mixture directly to the soil of the agricultural extension to be treated.

The product of the invention can be applied separately, for use as a soil conditioner, desaliniser or to improve cationic exchange capacity, or mixed with other products of agricultural use such as organic or inorganic fertilisers or compost, for example. The product of the invention is mixed with other nutrients to enhance their effects, as it will complex or chelate them helping plants use a greater percentage of them and of any already present in the soil, as well as producing the same effects as when applied alone.

In another embodiment of the invention, said application may be mechanical or manual, preferably mechanical. In the latter case a hopper (revolving or otherwise) is used mounted on a tractor or trailer to release the product contained in it, which generally is a mixture of several different granules, each with a specific purpose.

The product of the invention can also be applied to the soil manually, spreading it by hand or with shovels.

Lastly, the product of the invention can be used for “base tasks”, this is, placing it on the base of the furrows or holes that will later receive transplanted plants or seeds.

Some examples of the application of the product of the invention are given below.

Agricultural Operation WITH a Mechanical Hopper for Applying Granules

According to the recommendations of the Agricultural Technical Advisor (an agricultural engineer or other advisor) the sacks with various granules are mixed in the soil application hopper in the proper proportions and applied at the same time to the field.

Agricultural Operation WITHOUT a Mechanical Hopper for Applying Granules

According to the recommendations of the Agricultural Technical Advisor (an agricultural engineer or other advisor) the application is performed by hand or with a shovel.

1-17. (canceled)

18. Product for agricultural application in the form of granules or pellets, characterised in that it comprises at least 4% (w/w) of vinasses and/or sludge measured as a dry extract of vinasses and/or sludge and an organic or inorganic solid support.

19. Product according to claim 18, characterised in that it comprises 4-95% (w/w) of vinasses and/or sludge measured as a dry extract of vinasses and/or sludge and the rest, that is 96-5%, is the solid support needed to manufacture the granule or pellet.

20. Product according to claim 19, characterised in that it comprises 4-50% (w/w) of vinasses and/or sludge measured as a dry extract of vinasses and/or sludge and the remaining 96-50% is a solid support.

21. Product according to claim 20, characterised in that it comprises 13% (w/w) of vinasses and/or sludge measured as a dry extract of vinasses and/or sludge and 87% solid support.

22. Procedure for producing a product of agricultural use in the form of granules or pellets comprising at least 4% (w/w) of vinasses and/or sludge measured as a dry extract of vinasses and/or sludge and an organic or inorganic solid support, characterised in that it comprises a step of addition of the vinasses in solid or liquid form to a solid support for granulation or pelletisation.

23. Procedure according to claim 22, characterised in that it comprises a step of addition of the liquid vinasses concentrated at least 25% (w/w) to a solid support for granulation or pelletisation.

24. Procedure according to claim 22, characterised in that it comprises a step of addition of the solid vinasses and/or sludge in the form of powder to a solid support for granulation or pelletisation.

25. Procedure according to claims 22, 23 or 24, characterised in that the solid support for granulation or pelletisation can be an organic or inorganic substance.

26. Procedure according to claim 25, characterised in that the solid support for granulation or pelletisation is an organic substance, preferably cane bagasse or composted organic matter.

27. Procedure according to claim 25, characterised in that the solid support for granulation or pelletisation is an inorganic substance, preferably clay, silicates, nitrates or sulphates.

28. Use of a product for agricultural use in the form of granules or pellets comprising at least 4% (w/w) of vinasses and/or sludge measured as a dry extract of vinasses and/or sludge, and an organic or inorganic solid support in agriculture.

29. Use according to claim 28, characterised in that said product in the form of granules or pellets comprising at least 4% (w/w) of vinasses and/or sludge measured as a dry extract of vinasses and/or sludge, and an organic or inorganic solid support is used preferably as a fertiliser, a nutrient enhancer, a soil conditioner, a desaliniser, a nutrient complexing and/or chelating agent, a stabiliser of the organic matter in the soil, a mixture enhancer, a pH improver and regulator, a cationic exchange capacity improver, or as organic matter of almost immediate availability.

30. Method for application to an agricultural extension to be treated of a product of agricultural use in the form of granules or pellets comprising at least 4% (w/w) of vinasses and/or sludge measured as a dry extract of vinasses and/or sludge, and an organic or inorganic solid support, characterised in that it involves applying said product directly to the soil of said agricultural extension to be treated.

31. Method for application according to claim 30, characterised in that it involves: 1) mixing, with other products of agricultural use in the form of granules or pellets, the product in the form of granules or pellets comprising at least 4% (w/w) of vinasses and/or sludge measured as a dry extract of vinasses and/or sludge, and an organic or inorganic solid support; and 2) applying said mixture directly to the soil of the agricultural extension to be treated.

32. Method for application according to claims 30 or 31, characterised in that it consists of a mechanical or manual application, preferably mechanical.
